(19) United States
(12) Patent Application Publication
(10) Pub. No.: US 2016/0248277 A1
(43) Pub. Date: Aug. 25, 2016

(54) RESONANT TYPE HIGH FREQUENCY POWER SUPPLY DEVICE AND SWITCHING CIRCUIT FOR RESONANT TYPE HIGH FREQUENCY POWER SUPPLY DEVICE

(71) Applicant: MITSUBISHI ELECTRIC ENGINEERING COMPANY, LIMITED, Chiyoda-ku, Tokyo (JP)

(72) Inventors: Yoshiyuki AKUZAWA, Chiyoda-ku (JP); Kiyohide SAKAI, Chiyoda-ku (JP); Toshihiro EZOE, Chiyoda-ku (JP); Yuki ITO, Chiyoda-ku (JP)

(73) Assignee: MITSUBISHI ELECTRIC ENGINEERING COMPANY, LIMITED, Chiyoda-ku, Tokyo (JP)

(21) Appl. No.: 15/027,634

(22) PCT Filed: Oct. 31, 2013
(86) PCT No.: PCT/JP2013/079543

§ 371 Date: Apr. 6, 2016

(51) Int. Cl. H02J 50/12; H02J 50/20

(52) U.S. Cl. CPC H02J 50/12; H02J 50/20

(57) ABSTRACT

A resonant type high frequency power supply device provided with a power semiconductor element that performs a switching operation, the resonant type high frequency power supply device including a high frequency pulse drive circuit that transmits a pulse-shaped voltage signal having a high frequency exceeding 2 MHz to the power semiconductor element to drive the above-mentioned power semiconductor element, a variable pulse signal generating circuit that transmits a pulse-shaped voltage signal having a high frequency exceeding 2 MHz to the high frequency pulse drive circuit to drive the above-mentioned high frequency pulse drive circuit, and a bias power supply circuit that supplies driving power to both the variable pulse signal generating circuit and the high frequency pulse drive circuit.

### FIELD OF THE INVENTION

The present invention relates to a resonant type high frequency power supply device and a switching circuit for the resonant type high frequency power supply device that perform power transmission at a high frequency.

### BACKGROUND OF THE INVENTION

In a conventional resonant type high frequency power supply device shown in FIG. 14, a high frequency FET (Field Effect Transistor) for RF (Radio Frequency) is used as a power element Q1. A drive circuit of transformer type 101 and an RF power amplifier circuit 102 are used to drive this high frequency FET, and a multi-output type power supply circuit 103 is further used to drive the RF power amplifier circuit 102 (for example, refer to nonpatent reference 1).

### RELATED ART DOCUMENT

### Nonpatent Reference

Nonpatent reference 1: Transistor Technology, February 2005, Chapter 13

### SUMMARY OF THE INVENTION

### Problems to be Solved by the Invention

However, a problem with the conventional configuration disclosed by nonpatent reference 1 is that because the drive circuit of transformer type 101, the RF power amplifier circuit 102 and the multi-output type power supply circuit 103 are used to drive the power element Q1, the circuit configuration is complicated and the component count increases, and hence the device is upsized and the cost also increases. A further problem is that because the power consumption in each of the above-mentioned circuits 101 to 103 is large, the power consumption in the whole of the resonant type high frequency power supply device also becomes large, and this results in a reduction in the power conversion efficiency.

The present invention is made in order to solve the above-mentioned problems, and it is therefore an object of the present invention to provide a resonant type high frequency power supply device and a switching circuit for the resonant type high frequency power supply device that achieve simplification, downsizing and a cost reduction thereof and also achieve high efficiency with low power consumption and that can operate at a high frequency exceeding 2 MHz, by driving a power element without using a drive circuit of transformer type, an RF power amplifier circuit and a multi-output power supply circuit.

### Means for Solving the Problem

In accordance with the present invention, there is provided a resonant type high frequency power supply device provided with a power element that performs a switching operation, the resonant type high frequency power supply device including: a high frequency pulse drive circuit that transmits a pulse-shaped voltage signal at a high frequency exceeding 2 MHz to the power element to drive the above-mentioned power element; a variable pulse signal generating circuit that transmits a pulse-shaped voltage signal at a high frequency exceeding 2 MHz to the high frequency pulse drive circuit to drive the above-mentioned high frequency pulse drive circuit; and a bias power supply circuit that supplies driving power to both the variable pulse signal generating circuit and the high frequency pulse drive circuit.

### Advantages of the Invention

Because the resonant type high frequency power supply device in accordance with the present invention is configured as above, the resonant type high frequency power supply device achieves simplification, downsizing and a cost reduction thereof and also achieves high efficiency with low power consumption, and can operate at a high frequency exceeding 2 MHz, by driving the power element without using a drive circuit of transformer type, an RF power amplifier circuit and a multi-output power supply circuit.

### BRIEF DESCRIPTION OF THE FIGURES

FIG. 1 is a diagram showing the configuration of a resonant type high frequency power supply device in accordance with Embodiment 1 of the present invention (in a case in which a power element has a single configuration);

FIG. 2 is a diagram showing another example of the configuration of the resonant type high frequency power supply device in accordance with Embodiment 1 of the present invention (in a case in which a hybridized element is used);

FIG. 3 is a diagram showing another example of the configuration of the resonant type high frequency power supply device in accordance with Embodiment 1 of the present invention (in a case in which a hybridized element is used);

FIG. 4 is a diagram showing another example of the configuration of the resonant type high frequency power supply device in accordance with Embodiment 1 of the present invention (in a case in which a hybridized element is used);

FIG. 5 is a diagram showing another example of the configuration of the resonant type high frequency power supply device in accordance with Embodiment 1 of the present invention (in a case in which a hybridized element is used);

FIG. 6 is a diagram showing another example of the configuration of the resonant type high frequency power supply device in accordance with Embodiment 1 of the present invention (in a case in which a hybridized element is used);

FIG. 7 is a diagram showing another example of the configuration of the resonant type high frequency power supply device in accordance with Embodiment 1 of the present invention (in a case in which a hybridized element is used);

FIG. 8 is a diagram showing another example of the configuration of the resonant type high frequency power supply device in accordance with Embodiment 1 of the present invention (in a case in which a hybridized element is used);

FIG. 9 is a diagram showing another example of the configuration of the resonant type high frequency power supply device in accordance with Embodiment 1 of the present invention (in a case in which a hybridized element is used);

FIG. 10 is a diagram showing another example of the configuration of the resonant type high frequency power supply device in accordance with Embodiment 1 of the present invention (in a case in which a hybridized element is used);

FIG. 11 is a diagram showing another example of the configuration of the resonant type high frequency power supply device in accordance with Embodiment 1 of the present invention (in a case in which the power elements have a push-pull configuration);

FIG. 12 is a diagram showing another example of the configuration of the resonant type high frequency power supply device in accordance with Embodiment 1 of the present invention (in a case in which a variable resonance condition LC circuit is disposed);

FIG. 13 is a diagram showing another example of the configuration of the resonant type high frequency power supply device in accordance with Embodiment 1 of the present invention (in a case in which a variable resonance condition circuit is disposed); and

FIG. 14 is a diagram showing the configuration of a conventional resonant type high frequency power supply device.

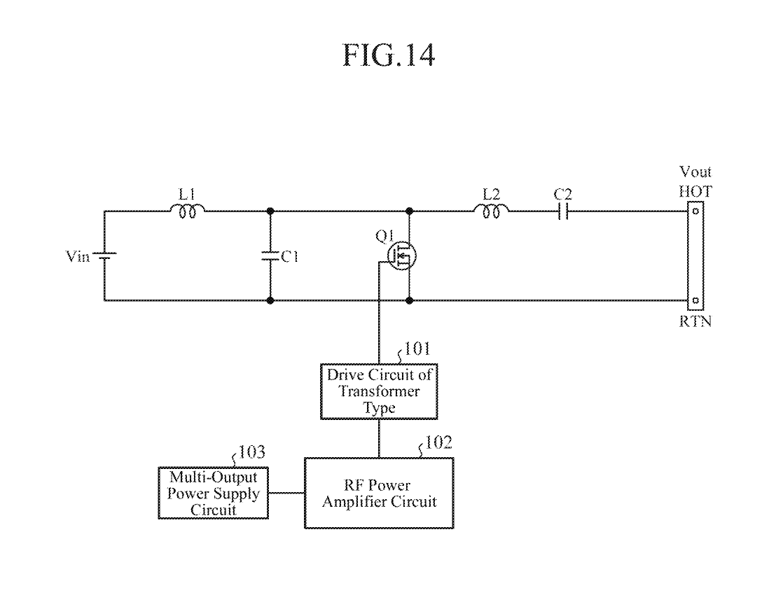

### EMBODIMENTS OF THE INVENTION

Hereafter, the preferred embodiments of the present invention will be explained in detail with reference to the drawings.

### Embodiment 1

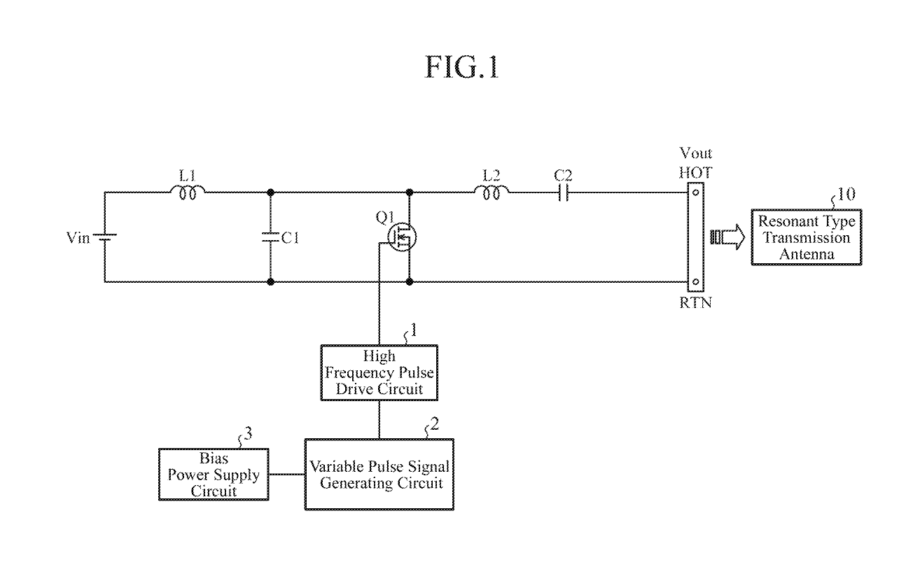

FIG. 1 is a diagram showing the configuration of a resonant type high frequency power supply device in accordance with Embodiment 1 of the present invention. In FIG. 1, a power element Q1 represents a circuit in a case of a single configuration.

The resonant type high frequency power supply device is comprised of the power element Q1, a resonance circuit element (capacitors C1 and C2 and an inductor L2), an inductor L1, a high frequency pulse drive circuit 1, a variable pulse signal generating circuit 2 and a bias power supply circuit 3, as shown in FIG. 1.

A resonant type transmission antenna (a transmission antenna for power transmission) 10 is a resonant type antenna for power transmission having LC resonance characteristics (which is not limited only to a noncontact type one). This resonant type transmission antenna 10 can be of any of magnetic resonance type, electric resonance type, and electromagnetic induction type.

The power element Q1 is a switching element that performs a switching operation in order to convert a direct voltage Vin, which is an input, into an alternating voltage. As this power element, Q1, not only an FET for RF but also an element, such as an Si-MOSFET, an SiC-MOSFET or a GaN-FET, can be used.

The resonance circuit element (the capacitors C1 and C2 and the inductor L2) is an element that causes the power element Q1 to perform resonant switching in the switching operation. By using this resonance circuit element which consists of the capacitors C1 and C2 and the inductor L2, the resonance condition can be caused to match that of the resonant type transmission antenna 10.

The inductor L1 works to hold the energy of the DC input voltage Vin temporarily, every time when the power element Q1 performs the switching operation.

The high frequency pulse drive circuit 1 is a circuit that transmits a pulse-shaped voltage signal at a high frequency exceeding 2 MHz to a G terminal of the power element Q1, to drive the power element Q1. This high frequency pulse drive circuit 1 is a circuit which is provided a totem pole output circuit by using an FET or such a device to be able to perform a high-speed ON/OFF output.

The variable pulse signal generating circuit 2 is a circuit that transmits a pulse-shaped voltage signal at a high frequency exceeding 2 MHz, such as a logic signal, to the high frequency pulse drive circuit 1, to drive the high frequency pulse drive circuit 1. This variable pulse signal generating circuit 2 is comprised of an oscillator for frequency setting and logic ICs such as an inverter and a flip-flop, and has functions such as a function of changing a pulse width and a function of outputting reverse pulses.

The bias power supply circuit 3 supplies driving power to both the variable pulse signal generating circuit 2 and the high frequency pulse drive circuit 1.

Next, the operation of the resonant type high frequency power supply device configured as above will be explained.

First, the input direct voltage Vin is applied to a D terminal of the power element Q1 through the inductor L1. The power element Q1 then converts the voltage into a positive voltage in an alternating form by performing the ON/OFF switching operation. At the time of this conversion operation, the inductor L1 works to hold the energy temporarily, thereby helping the conversion of the direct voltage to the alternating voltage.

In this embodiment, in the switching operation of the power element Q1, in order to minimize a switching loss due to the product of an Ids current and a Vds voltage, the resonant switching condition is set to conduct a ZVS (zero voltage switching) to the resonance circuit device which consists of the capacitors C1, C2 and the inductor L2. By performing this resonant switching operation, the alternating voltage centered on an RTN voltage is outputted as an output voltage Vout.

The driving of the power element Q1 is performed by inputting the pulse-shaped voltage signal, which the high frequency pulse drive circuit 1 which has received the arbitrary pulse-shaped voltage signal from the variable pulse signal generating circuit 2 outputs, to the G terminal of the power element Q1. At that time, the driving frequency of the power element Q1 serves as the operating frequency of the resonant type high frequency power supply device, and is determined by a setting made on the oscillator circuit disposed in the variable pulse signal generating circuit 2.

As mentioned above, because the resonant type high frequency power supply device in accordance with Embodiment 1 is configured in such a way as to output the pulse-shaped voltage signal by using the high frequency pulse drive circuit 1, the variable pulse signal generating circuit 2 and the bias power supply circuit 3 in order to drive the power element Q1, simplification, downsizing and a cost reduction can be achieved on the resonant type high frequency power supply device that performs a high frequency operation exceeding 2 MHz, without using a drive circuit of transformer type 101, an RF power amplifier circuit 102 and a multi-output power supply circuit 103 for use in a conventional technology. Further, 90% or more high power conversion efficiency characteristics can be provided with low power consumption.

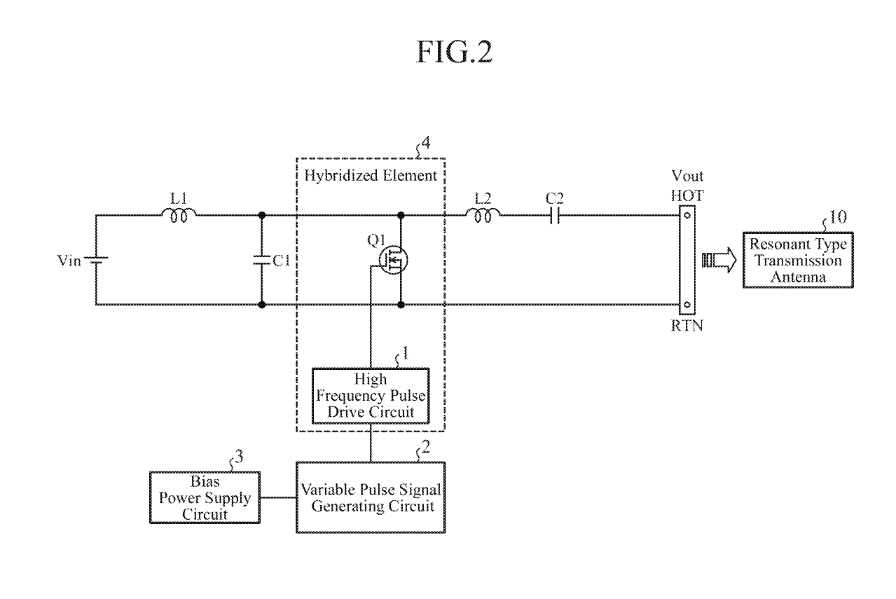

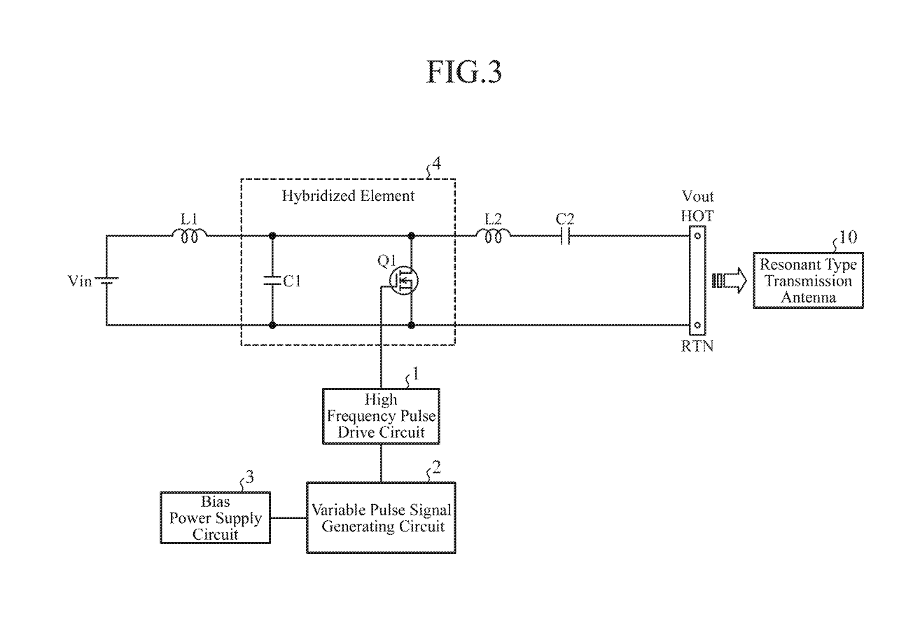

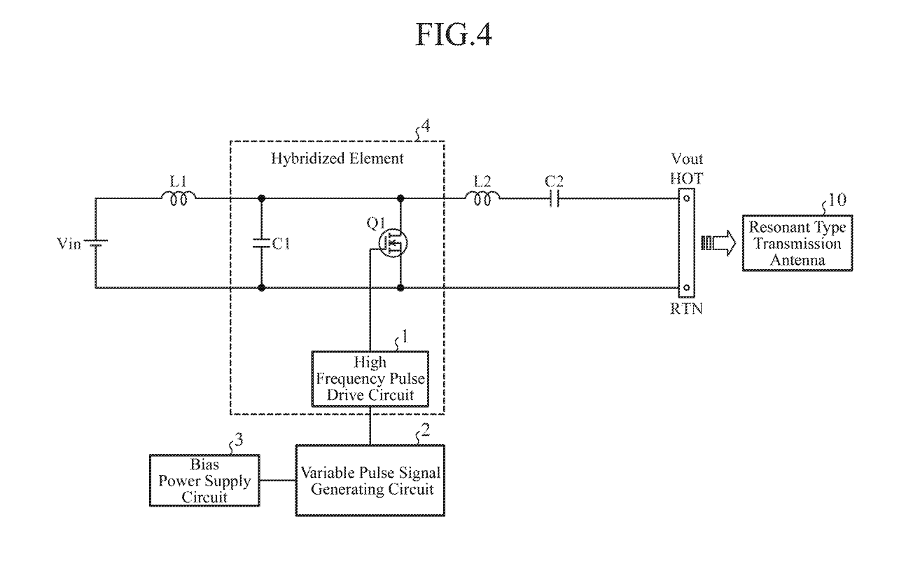

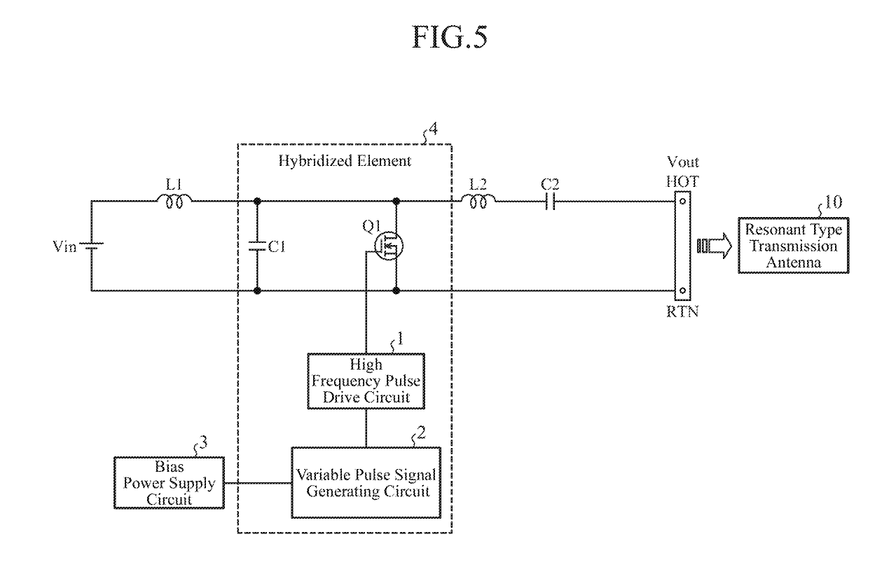

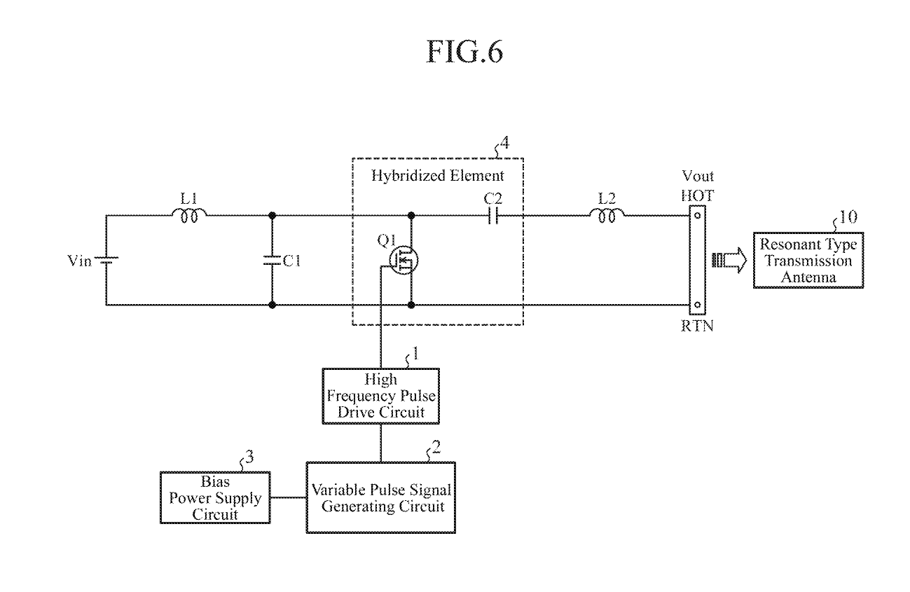

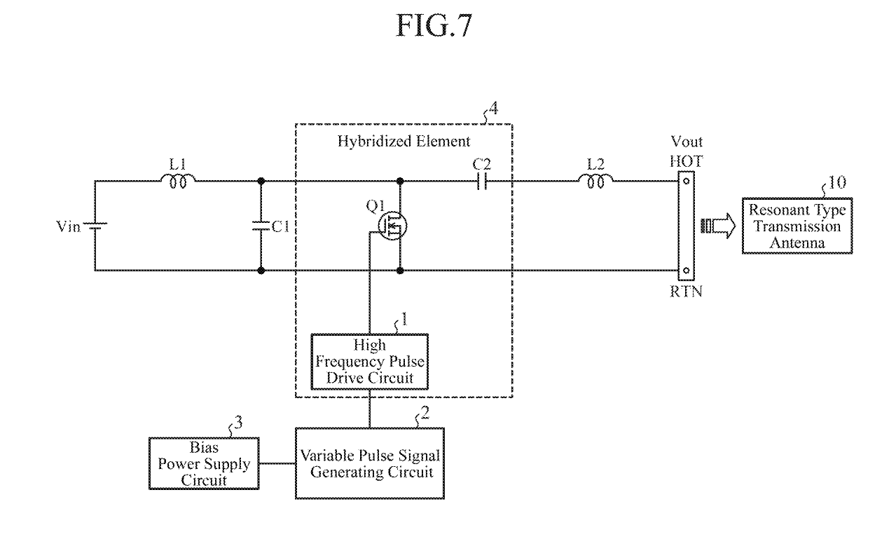

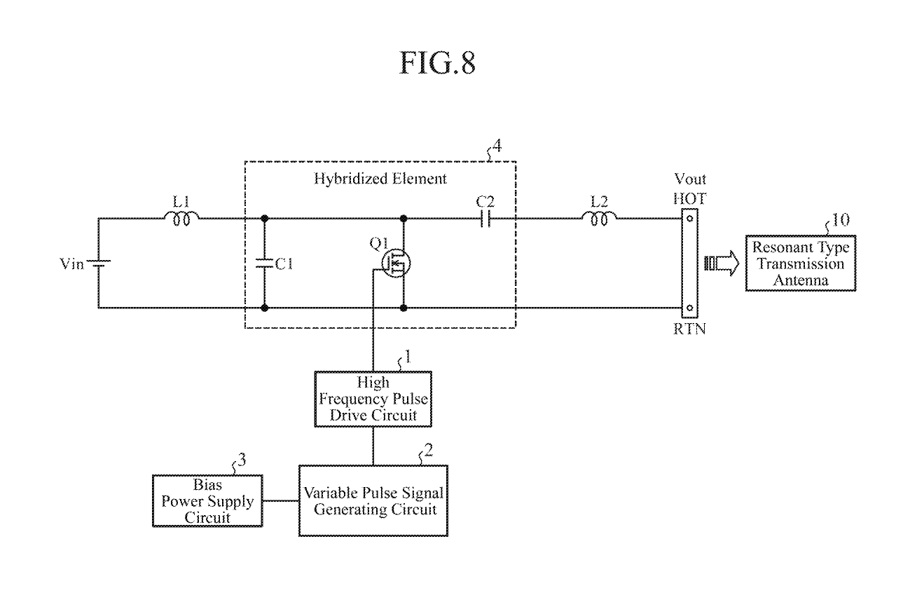

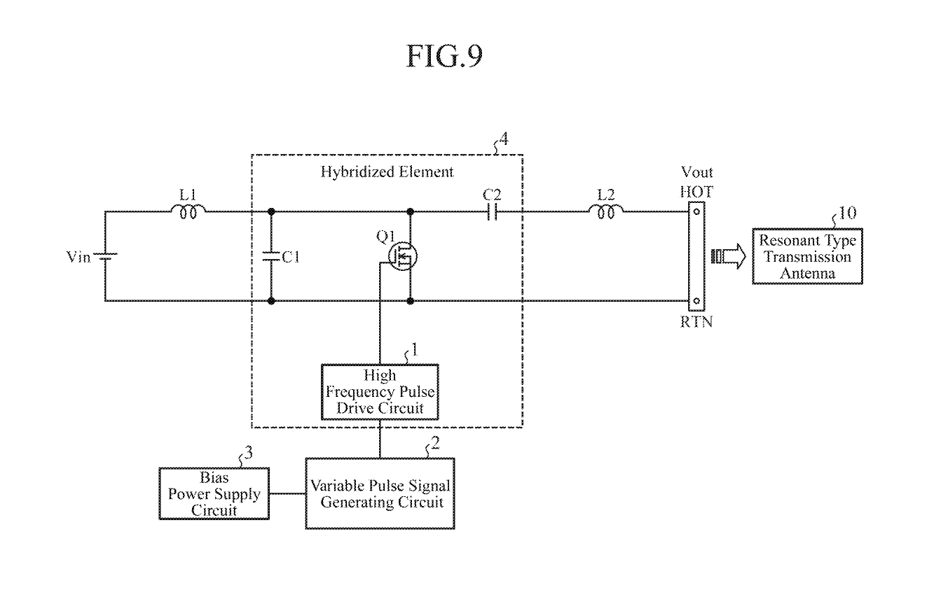

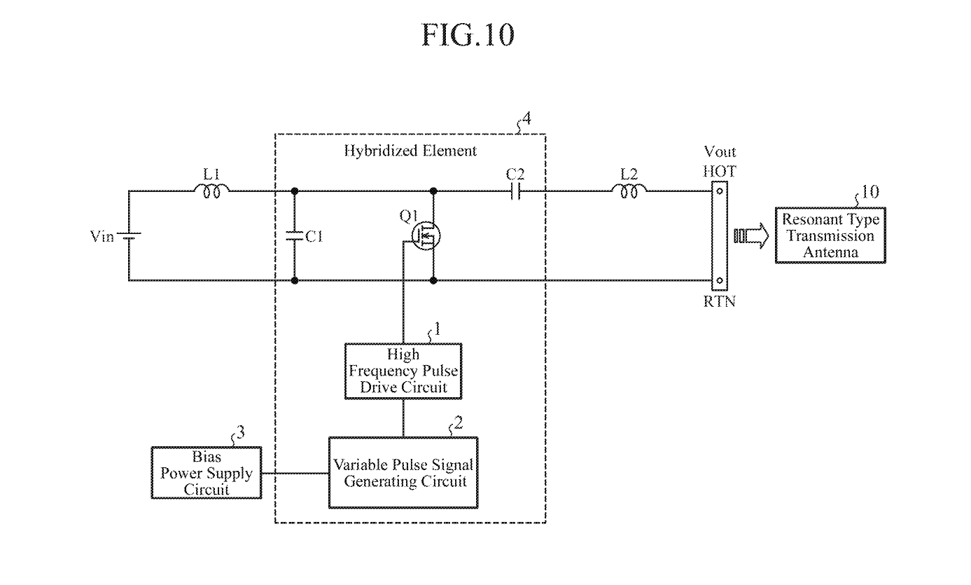

In the example shown in FIG. 1, an element (a switching circuit for the resonant type high frequency power supply device) 4 in which some components are hybridized can be used. FIG. 2 shows an element 4 in which the power element Q1 and the high frequency pulse drive circuit 1 are hybridized, FIG. 3 shows an element 4 in which the power element Q1 and the capacitor C1 are hybridized, FIG. 4 shows an element 4 in which the power element Q1, the capacitor C1, and the high frequency pulse drive circuit 1 are hybridized, FIG. 5 shows an element 4 in which the power element Q1, the capacitor C1, the high frequency pulse drive circuit 1 and the variable pulse signal generating circuit 2 are hybridized, FIG. 6 shows an element 4 in which the power element Q1 and the capacitor C2 are hybridized, FIG. 7 shows an element 4 in which the power element Q1, the capacitor C2 and the high frequency pulse drive circuit 1 are hybridized, FIG. 8 shows an element 4 in which the power element Q1 and the capacitors C1 and C2 are hybridized, FIG. 9 shows an element 4 in which the power element Q1, the capacitors C1 and C2 and the high frequency pulse drive circuit 1 are hybridized, and FIG. 10 shows an element 4 in which the power element Q1, the capacitors C1 and C2, the high frequency pulse drive circuit 1 and the variable pulse signal generating circuit 2 are hybridized.

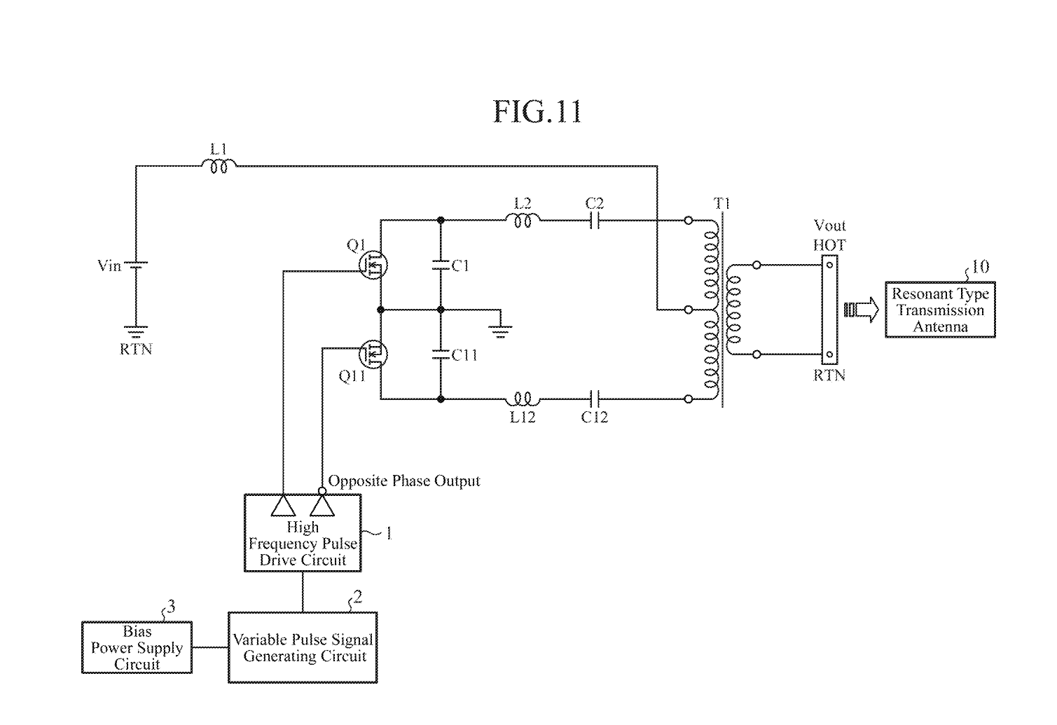

Further, although the circuit in the case in which the power element Q1 has a single configuration is shown in FIG. 1, this embodiment is not limited to this example. For example, as shown in FIG. 11, the present invention can be similarly applied to a case in which the power element Q1 has a push-pull configuration.

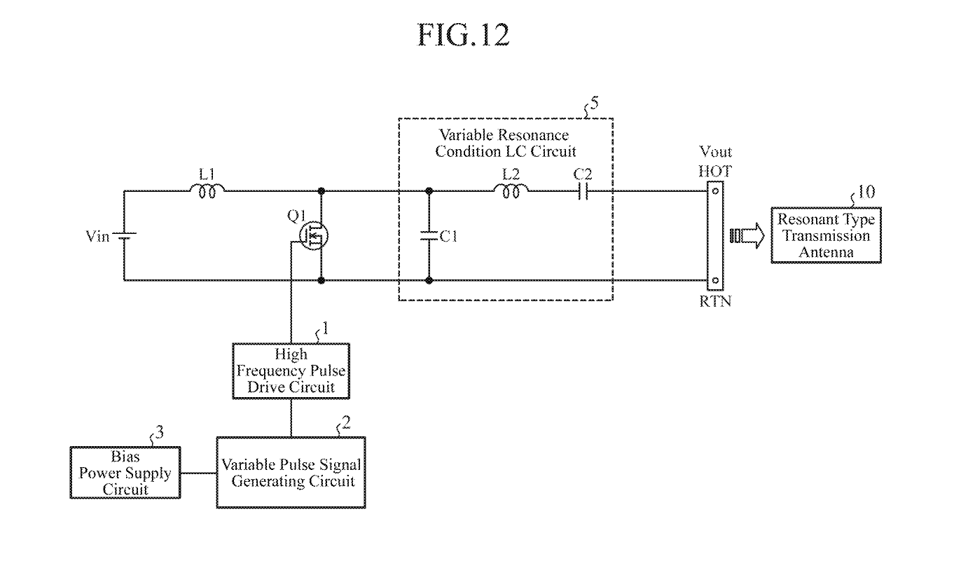

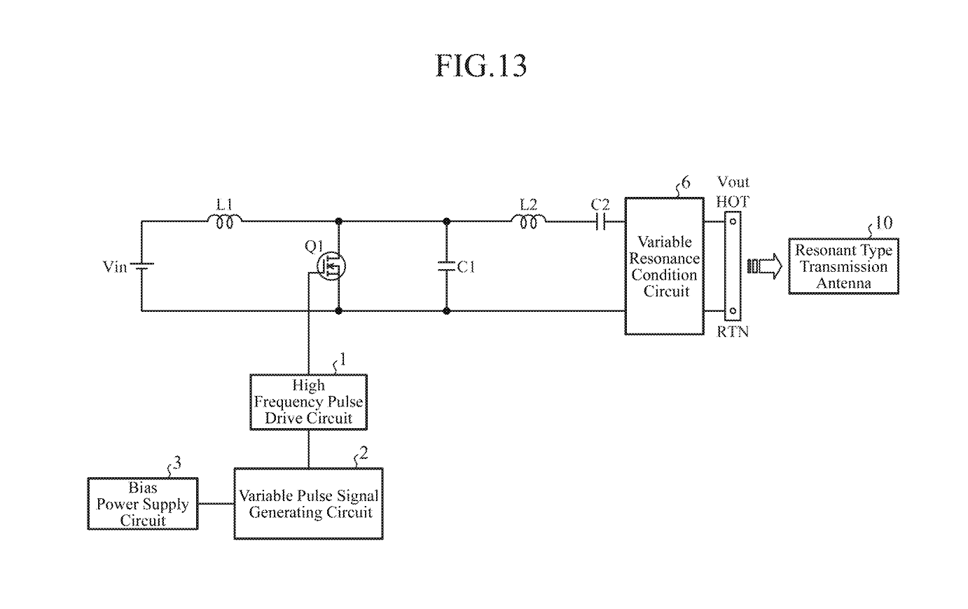

Further, although the explanation about FIG. 1 is made by assuming that the constants of the resonance circuit element (the capacitors C1 and C2 and the inductor L2) are fixed and hence the resonance condition is fixed, this embodiment is not limited to this example. For example, as shown in FIG. 12, a variable resonance condition LC circuit 5 that causes the resonance condition to be variable can be alternatively used. Further, for example, as shown in FIG. 13, a variable resonance condition circuit 6 that causes the resonance condition according to the above-mentioned resonance circuit element (the capacitors C1 and C2 and the inductor L2) to be variable can be disposed separately.

Further, while the invention has been described in its preferred embodiment, it is to be understood that various changes can be made in an arbitrary component in accordance with the embodiment, and an arbitrary component in accordance with the embodiment can be omitted within the scope of the invention.

### INDUSTRIAL APPLICABILITY

The resonant type high frequency power supply device and the switching circuit for the resonant type high frequency power supply device in accordance with the present invention achieve simplification, downsizing and a cost reduction thereof and also achieve high efficiency with low power consumption, and can operate at a high frequency exceeding 2 MHz, by driving the power element without using a drive circuit of transformer type, an RF power amplifier circuit and a multi-output power supply circuit. Therefore, the resonant type high frequency power supply device and the switching circuit for the resonant type high frequency power supply device are suitable for use as a resonant type high frequency power supply device and a switching circuit for the resonant type high frequency power supply device that perform power transmission at a high frequency, etc.

### EXPLANATIONS OF REFERENCE NUMERALS

1 high frequency pulse drive circuit, 2 variable pulse signal generating circuit, 3 bias power supply circuit, 4 hybridized element (switching circuit for resonant type high frequency power supply device), 5 variable resonance condition LC circuit, 6 variable resonance condition circuit, and 10 resonant type transmission antenna (transmission antenna for power transmission).

1. A resonant type high frequency power supply device provided with a power semiconductor element that performs a switching operation, said resonant type high frequency power supply device comprising:
a high frequency pulse drive circuit that transmits a pulse-shaped voltage signal having a high frequency exceeding 2 MHz to said power semiconductor element to drive said power semiconductor element;
a variable pulse signal generating circuit that transmits a pulse-shaped voltage signal having a high frequency exceeding 2 MHz to said high frequency pulse drive circuit to drive said high frequency pulse drive circuit; and
a bias power supply circuit that supplies driving power to both said variable pulse signal generating circuit and said high frequency pulse drive circuit.

2. The resonant type high frequency power supply device according to claim 1, wherein said power semiconductor element is an FET (Field Effect Transistor) other than an FET for RF (Radio Frequency).

3. The resonant type high frequency power supply device according to claim 1, wherein said power semiconductor element has a push-pull configuration or a single configuration.

4. The resonant type high frequency power supply device according to claim 1, wherein said resonant type high frequency power supply device includes a resonance circuit element that causes a resonance condition to match that of a transmission antenna for power transmission according to magnetic resonance and that is comprised of a capacitor and an inductor.

5. The resonant type high frequency power supply device according to claim 1, wherein said resonant type high frequency power supply device includes a resonance circuit element that causes a resonance condition to match that of a transmission antenna for power transmission according to electric resonance and that is comprised of a capacitor and an inductor.

6. The resonant type high frequency power supply device according to claim 1, wherein said resonant type high frequency power supply device includes a resonance circuit element that causes a resonance condition to match that of a transmission antenna for power transmission according to electromagnetic induction and that is comprised of a capacitor and an inductor.

7. The resonant type high frequency power supply device according to claim 4, wherein said resonance circuit element causes the resonance condition to be variable.

8. The resonant type high frequency power supply device according to claim 5, wherein said resonance circuit element causes the resonance condition to be variable.

9. The resonant type high frequency power supply device according to claim 6, wherein said resonance circuit element causes the resonance condition to be variable.

10. The resonant type high frequency power supply device according to claim 4, wherein said resonant type high frequency power supply device includes a variable resonance condition circuit that causes the resonance condition of said resonance circuit element to be variable.

11. The resonant type high frequency power supply device according to claim 5, wherein said resonant type high frequency power supply device includes a variable resonance condition circuit that causes the resonance condition of said resonance circuit element to be variable.

12. The resonant type high frequency power supply device according to claim 6, wherein said resonant type high frequency power supply device includes a variable resonance condition circuit that causes the resonance condition of said resonance circuit element to be variable.

13. A switching circuit for a resonant type high frequency power supply device, said switching circuit including a power semiconductor element that performs a switching operation and being used for the resonant type high frequency power supply device, said switching circuit comprising:
said power semiconductor element; and
a high frequency pulse drive circuit that transmits a pulse-shaped voltage signal having a high frequency exceeding 2 MHz to said power semiconductor element to drive said power semiconductor element.

14. The switching circuit for the resonant type high frequency power supply device according to claim 13, wherein said switching circuit includes a capacitor that causes a resonance condition to match that of a transmission antenna for power transmission.

15. The switching circuit for the resonant type high frequency power supply device according to claim 14, wherein said switching circuit includes a variable pulse signal generating circuit that transmits a pulse-shaped voltage signal having a high frequency exceeding 2 MHz to said high frequency pulse drive circuit to drive said high frequency pulse drive circuit.
